(19) United States
(12) Patent Application Publication
(10) Pub. No.: US 2011/0266119 A1
(43) Pub. Date: Nov. 3, 2011

(54) Multiple Switch Having A Rotationally Adjustable Element

(76) Inventor: Christopher Adams, Hamburg (DE)

(21) Appl. No.: 13/120,951

(22) PCT Filed: Sep. 25, 2009
(86) PCT No.: PCT/EP2009/062444

§ 371 Date: May 23, 2011

(30) Foreign Application Priority Data
Sep. 26, 2008 (EP) 08165299.2

(51) Int. Cl. H01H 21/02

(52) U.S. Cl. 200/17 R

(57) ABSTRACT

The invention relates to a switch containing a switch head and a switch lever which is designed in such a manner that at least two electrical contacts can be switched by means of the switch head when the switch lever is tilted. Similar flip switches are known in numerous designs and styles. Adjusting elements such as potentiometers are also known. The prior art further discloses combinations of push switches and adjusting elements. These combinations are however disadvantageous in that the switch can only switch between two states. The aim of the invention is therefore to devise a flip switch which allows switching between a plurality of switching states and which comprises an adjusting element. The switch according to the invention comprises a switch lever containing a switch shaft and contains at least one adjusting element which is connected to the switch shaft in such a manner that the adjusting element can be adjusted by rotating the switch shaft.

### CROSS-REFERENCE TO RELATED APPLICATION

This application is a national stage of and claims the benefit of priority of International Patent Application No. PCT/EP2009/062444, filed on Sep. 25, 2009, which is relied on and incorporated herein by reference.

### FIELD OF THE INVENTION

The invention relates to a switch, containing a switch head and a switch lever, which is arranged in such a way that by tilting the switch lever with the switch head, at least two electrical contacts can be switched.

### BACKGROUND OF THE INVENTION

Such flip switches are known in numerous designs and construction styles. Adjustable elements, such as, for example, potentiometers are also known.

Moreover, in the state of the art, combinations of push switches and adjusting elements are known. However, these combinations present the disadvantage that the switch can be switched between only two states.

### SUMMARY OF THE INVENTION

The problem of the present invention is thus to provide a flip switch which makes it possible to switch between several switch states, and which also presents an adjustable element.

A switch according to the invention thus contains a switch head and a switch lever which is arranged in such a way that by tilting the switch lever with the switch head, at least two electrical contacts can be switched. Moreover, the switch lever according to the invention contains a switch shaft and at least one adjustable element which is connected with the switch shaft in such a way that the adjustable element can be adjusted by rotating the switch shaft.

The switch according to the invention thus combines the switch lever of a flip switch with the switch shaft for an adjustable element.

Thus, the switch shaft can be a part of the switch lever, or it is also possible for the switch lever itself to be the switch shaft.

The electrical contacts which are switched by the switch head can be produced in a variety of ways which are already known. The person skilled in the art can choose suitable electrical contacts, as a function of the requirement.

As adjusting element, one can consider using numerous different technical solutions, such as, for example, electrical or mechanical adjustable elements. Thus, the adjustable element can be, for example, a valve.

The switch according to the invention makes it possible to position operating elements for numerous functions in the smallest space. This leads not only to space savings, it also considerably simplifies the operation and shortens the time required to perform it. In addition, the functionality of the switch is clearly improved, and the flexibility during use is increased.

In one embodiment, a switch is designed in such a way that the switch lever is a switch shaft, attached preferably via a ball seat in a holder bushing, in such a way that the switch shaft can be rotated and tilted. For this purpose, the switch shaft presents a spherical thickening which is held in a ball seat. By means of such an embodiment, a simple and material-saving construction style is possible.

If the switch shaft is only a part of the switch lever, the external area of the switch shaft can present a spherical thickening, which is held in the ball seat.

However, if the switch shaft is, for example, a pivoted internal part of the switch lever, the external part of the switch lever does not have to be mounted in such a way as to allow rotation and tilting. In this case, it is sufficient for the tiltability of the external part of the switch lever to be adjusted securely, because the switch shaft is pivoted inside the switch lever.

In a preferred embodiment, the switch shaft is led rotatably through the switch head, and also pivoted preferably on the switch head. For such a lead-through, the switch head may comprise a simple hole or bearings, particularly ball bearings.

Such a design is particularly advantageous, because then the switch head cannot be rotated simultaneously during the rotation of the switch shaft, and thus the switching of the electrical contact can occur particularly reliably.

In another embodiment, at least one adjustable element is advantageously arranged at least partially inside the switch head and firmly connected to the switch head.

Such an arrangement is particularly space saving.

In another embodiment, the switch head, comprises a rectangular cross section, preferably with rounded corners, and is led in a receiver in such a way that prevents rotation of the switch head parallel to the rotation axis of the switch shaft.

To guide the switch head in embodiments of the invention, bent projections, rails or guide plates, for example, can be provided on the receiver.

By means of such an arrangement, it is possible to restrict the switch head in its movement to the effect that, although a flipping of the switch head and of the switch shaft is still possible, the switch head is, however, not also turned during the rotation of the switch shaft.

Such embodiments are particularly advantageous, because the switching of the electrical contact can be achieved particularly reliably, and the adjustable element can be attached without additional measures to the switch head, and then held non-rotatably with respect to the rotation of the switch shaft, so that an adjustment of the adjustable element by rotating the switch shaft is possible. It is particularly preferred to provide a holder bushing and attach it to the receiver, where the holder bushing presents means for the attachment of the switch, for example, to a housing.

In another embodiment of the invention, lines for the wiring of the at least one adjustable element are attached to the receiver in such a way that the lines do not prevent switching the at least two electrical contacts.

Depending on the application, in one embodiment of the invention, the at least one adjustable element is an electrical adjustable element, particularly a potentiometer.

In a preferred embodiment, at least two mutually insulated switch flags. Such switch flags consisting, for example, of sheet-metal blanks, can be used to form the electrical contacts.

The use of switch flags for the formation of the electrical contacts is particularly advantageous, because such switch flags can be produced in a simple way, and, due to their possible flexibility, represent a particularly reliable contact.

In another embodiment, at least one switch flag is arranged on both sides of the receiver, preferably in each case two mutually insulated switch flags, which are insulated from the receiver.

In such an arrangement, the electrical contact can then be established between the switch head and in each case one switch flag. If two switch flags are arranged in each case on both sides of the receiver, then the electrical contact can also be established, for example, by the fact that in each case two switch flags are pressed against each other through the switch head.

In still another embodiment of the invention, the switch head is designed so it is at least partially conductive, and, electrical connections to the switch head are provided on the receiver. In such an embodiment, an electrical contact can already be established by the fact that the switch head is brought in contact, for example, with a switch flag. If several switch flags are arranged one after the other in such an embodiment, several contact stages can be produced. Here, a first contact stage can be formed the switch head pressing against a first switch flag, and thus establishing an electrical contact between the switch head and the first switch flag. In a second switch stage, for example, the switch head which is pressed against the first switch flag can press the first switch flag against an additional switch flag.

This makes it possible, for example, to switch resistance cascades.

The electrical contact between the receiver and the switch head can here be established preferably via a sliding contact. However, it is also conceivable to provide a fixed cabling between the receiver and the switch head.

In a preferred embodiment, the receiver and/or at least one switch flag present means for the attachment of at least one electrical conductor.

However, depending on the requirement, in another embodiment, the switch head is designed so it is at least partially electrically insulating, and to provide at least three switch flags, of which, when flipping the switch lever, at least two are brought in electrical contact by the switch head. Such a design has the advantage that the switch head is without current. In this way, it is possible, in a simple way, to keep the switch shaft or the switch lever also potential free, without having to carry out additional insulation steps.

In another embodiment of the invention, on the at least two switch flags, in each case a means is provided for the attachment of at least one electrical conductor.

### BRIEF DESCRIPTION OF THE DRAWINGS

Additional advantages, variants and advantageous embodiments can be obtained from the embodiment example which is described in reference to the figures. The embodiment example and the figures are given purely as examples and in the form of diagrams, and they limit the invention in no way. The figures show, in detail:

FIG. 1, a switch according to the invention in a three-dimensional view, and

FIG. 2, an exploded representation of a switch according to the invention.

### DETAILED DESCRIPTION OF THE INVENTION

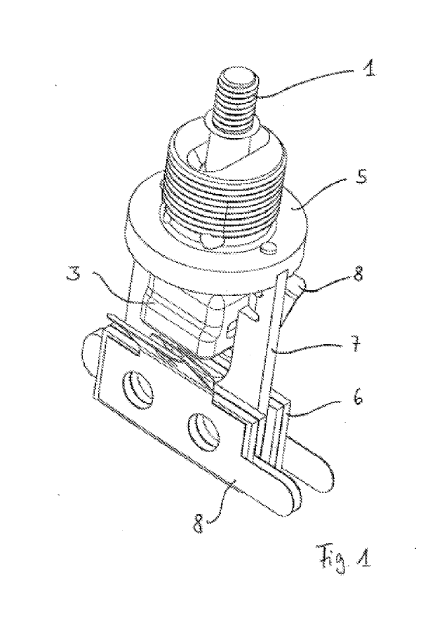

FIG. 1 shows a switch according to the invention with four switch flags 8, of which in each case two are positioned on one side of a receiver 7. The switch flags 8 are mutually insulated and they are insulated from the receiver 7. On the receiver 7, a holder bushing 5 is attached, which presents attachment means to attach the switch, for example, to a housing. A switch shaft 1 which can be rotated and tilted is led through the holder bushing. For the flipping of the switch shaft 1, appropriate recesses are provided in the holder bushing 5. Within the receiver 7 and beneath the holder bushing 5, a switch head 3 can be recognized. Inside the switch head 3, a potentiometer 4 attached to the switch head 3 is attached. This potentiometer 4 is connected to the switch shaft 1.

The receiver 7 comprises guide elements 9, which guide the switch head 3 in such a way that, while it is flippable, it cannot be rotated about the axis of the switch shaft.

The guide element 9 consists of bent projections.

Not shown in FIG. 1 are the electrical connections and feed lines of the potentiometer 4.

If the switch head 3 is moved by actuation of the switch shaft 1 which also functions as switch lever, then it first contacts one of the inwardly positioned switch flags 8, and subsequently presses one of the inwardly positioned switch flags 8 against the corresponding outwardly positioned switch flag 8, and thus establishes an electrical contact between the respective inwardly positioned switch flag 8, and the respective outwardly positioned switch flag 8.

In the embodiment example shown, two different electrical contacts can thus be switched. Furthermore, the potentiometer 4 can be adjusted by rotating the switch shaft 1.

The holes shown in the switch flags 8, the insulators located in between, and the receiver 7, serve for the introduction of holding pins or of screws, to hold the individual elements together. However, using them it is also possible to attach the switch.

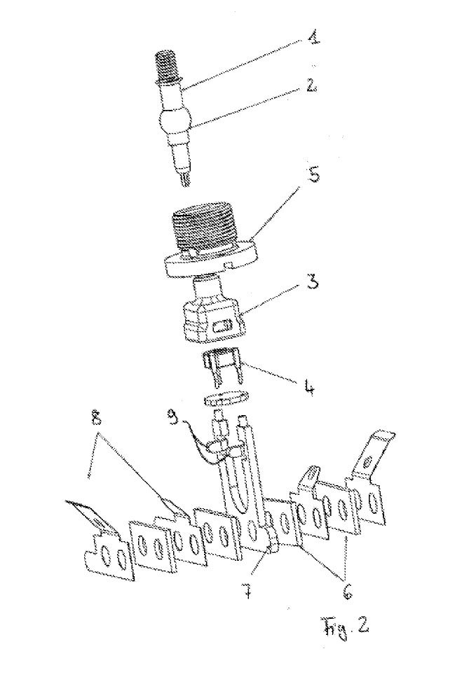

The exploded view shown in FIG. 2 shows the assembly of a switch according to the invention.

One can see that, on the right and on the left of the receiver 7, first insulators 6, and then in each case an internal switch flag 7, followed by an additional insulator 6 and the external switch flag 7, are arranged.

The switch shaft 1 presents a spherical thickening 2, by means of which it is attached in a manner that allows rotation and tilting in the holder bushing 5 in a ball seat. During the further course, the switch shaft 1 is led rotatably through the top side of the switch head 3, and ends in the interior of the potentiometer 4. The housing of the potentiometer 4 in turn is taken up partially in the switch head 3, and attached there. Thus, if the switch shaft 1 is twisted compared to the switch head 3, then the potentiometer 4 is readjusted.

The holder bushing 5 in turn is attached on the receiver 7.

The receiver 7 presents guides for the switch head 3, so that the latter can only be flipped about the ball seat respectively the spherical thickening 2, but it cannot be rotated along the axis of the switch shaft 1.

The embodiment example presents a comparatively simple assembly of a switch according to the invention; however, it clearly shows the advantages made possible by the invention. Further developments and variants can be found easily by the person skilled in the art, as a function of the problem at hand. In particular, the number of electrically switchable contacts can be adapted easily by the person skilled in the art to the problem at hand.

While the invention has been described with reference to exemplary structures and methods in embodiments, the invention is not intended to be limited thereto, but to extend to modifications and improvements within the scope of equivalence of such claims to the invention.

### LIST OF REFERENCE NUMERALS

1 Switch shaft

2 Spherical thickening

3 Switch head

4 Potentiometer

5 Holder bushing

6 Insulator

7 Receiver

8 Switch flag

9 Guide

1-14. (canceled)

15. A device comprising a switch head and a switch lever arranged with the switch lever flippable to switch at least two electrical contacts, wherein the switch lever includes a switch shaft, and at least one adjustable element coupled to the switch shaft to be rotated by rotation of the switch shaft.

16. The device according to claim 15, wherein the switch lever is a switch shaft rotatably and tiltably coupled to a holder bushing by a ball seat.

17. The device according to claim 15, wherein the switch shaft is rotatably coupled to a non-rotatable switch head.

18. The device according to claim 15, wherein the switch shaft is configured to feed through the switch head rotatably.

19. The device according to claim 15, wherein the at least one adjustable element is arranged at least partially inside the switch head and firmly connected to the switch shaft.

20. The device according to claim 15, wherein the switch head presents a rectangular cross section and is coupled to a receiver with the switch head restricted from rotation about all axes parallel to the rotation axis of the switch shaft.

21. The device according to claim 20, wherein a holder bushing is coupled to the receiver and includes a switch attachment.

22. The device according to one of claim 20, wherein wiring of the at least one adjustable element on the receiver is attached to allow flipping of the switch lever and switching of the at least two electrical contacts.

23. The device according to claim 22, wherein the at least one adjustable element is an electrical adjustable element.

24. The device according to claim 23, wherein the electrical adjustable element is a potentiometer.

25. The device according to claim 15, wherein the at least one adjustable element includes at least one of an electrical adjustable element and a mechanical adjustable element.

26. The device according to claim 15, wherein the at least two electrical contacts include at least two mutually insulated switch flags.

27. The device according to claim 20, wherein on each of two sides of the receiver one or more mutually insulated switch flags are arranged insulated from the receiver.

28. The device according to claim 20, wherein the receiver is electrically connected to the switch head and the switch head is at least partially conductive and can be brought into electrical contact with at least one switch flag.

29. The device according to claim 28, wherein one or both of the receiver and the at least one switch flag includes an attachment to at least one electrical conductor.

30. The device according to claim 15, wherein the switch head is at least partially electrically insulating and at least two of at least three switch flags can be brought into electrical contact with each other by the switch head during flipping of the switch lever.

31. The device according to claim 30, wherein the at least two switch flags include attachment to at least one electrical conductor.

32. The device according to claim 28, wherein the receiver is electrically connected by sliding contacts.

33. The device according to claim 20, wherein the rectangular cross section includes rounded corners.
